(19) United States
(12) Patent Application Publication
(10) Pub. No.: US 2004/0123750 A1
(43) Pub. Date: Jul. 1, 2004

(54) Sonic screen printing

(76) Inventor: Frederick F. Rezaei, Phoenix, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/335,245

(22) Filed: Dec. 31, 2002

(51) Int. Cl. B41F 15/12; B41F 15/40

(52) U.S. Cl. 101/114; 101/129

(57) ABSTRACT

A screen printing apparatus includes a source of solder paste. The solder paste further includes solder and flux. The screen printing apparatus also includes a stencil having openings therein, and an apparatus for forcing the solder paste into the openings of the stencil. The screen printing apparatus also includes a source of vibration attached to the stencil. In some embodiments, the source of vibration is an ultrasonic generator or a plurality of ultrasonic generators. The stencil can also include a frame. The source of vibration can be attached to the frame, or both the frame and the stencil. The source of vibration is positioned to overcome a surface tension between the solder paste and an opening in the stencil. A method for screen printing onto a substrate includes positioning a stencil having openings therein over a substrate, filling the openings in the stencil with solder paste, and vibrating the stencil to release the solder paste within the opening and deposit the solder paste onto the substrate.

### FIELD OF THE INVENTION

The present invention is related to ball grid array packages. More specifically, the present invention relates to methods and apparatus for forming a more co-planar structure for ball grid array packages.

### BACKGROUND OF THE INVENTION

The semiconductor industry has seen tremendous advances in technology in recent years that have permitted dramatic increases in circuit density and complexity, and equally dramatic reductions in power consumption and package sizes. Present semiconductor technology now permits single-chip microprocessors with many millions of transistors, operating at speeds of tens (or even hundreds) of MIPS (millions of instructions per second) to be packaged in relatively small, air-cooled semiconductor device packages. A by-product of such high density and high functionality in semiconductor devices has been the demand for increased numbers of external electrical connections to be present on the exterior of the die and on the exterior of the semiconductor package that receives the die, for connecting the packaged device to external systems, such as a printed circuit board.

To accommodate the increased number of pad sites needed for current and future dies, metal bumps are deposited at bonding pad sites, or lands, on the side of the die nearest the transistors and other circuit devices formed in the die. Connection of the die to the substrate forms a package. The connection is made when the die or chip is flipped over and soldered to the substrate. As a result, the dies are commonly called flip chips in the industry. Each bump connects to a corresponding package inner lead. The resulting packages have a low profile, short electrical paths, and low electrical resistance. The plurality of ball-shaped conductive bump contacts (usually solder, or other similar conductive material) are typically disposed in a rectangular array. It is not uncommon to have hundreds of solder balls in an array. The packages are occasionally referred to as “Ball Grid Array” (BGA) or “Area Grid Array” packages, or Chip Size Packages (CSP).

A BGA package is attached to a matching array of conductive pads on another device. The pads are connected to other devices within a substrate or circuitry on a circuit board. Heat and/or pressure is applied to reflow the solder balls (bumps) on the package, thereby wetting the pads on the substrates and, once cooled, forming electrical connections between the package and the semiconductor device contained in the package and the substrate.

Several methods may be employed to form the solder balls in an array. One of the techniques for forming the individual bumps in an array employs screen printing. A substrate is provided, with lands placed in an array with or without solder mask. A stencil is placed over lands. The stencil also has openings that correspond to the lands and, more specifically, to each land. Conductive material or solder paste, which includes solder suspended in flux, is forced into the openings in the stencil. The openings in the stencil assure that substantially the same amount of solder paste is deposited on each land. The stencil is then removed leaving the solder paste on the lands. The die or material is placed on the substrate or a printed wiring assembly board. Heat and/or pressure is applied, the flux is baked off (in case of solder paste), and a set amount of solder remains. Surface tension forms solder balls on the lands.

The screen printing method has limitations, especially as the pitch of the array decreases thereby requiring closer spacing between features. For example, the surface tension between the solder paste and the stencil has caused problems when screen printing at a sub-150 micron pitch. The surface tension between the solder paste and the stencil causes clogging of the apertures in the stencil. The result is that unequal amounts of solder paste are deposited on the lands since differing amounts of solder paste remain in the various openings of the stencil. This causes different amounts of solder paste to be deposited on the lands associated with the openings. The result is decreased yield, since the size of the resulting balls in the array may not be substantially the same. If the balls of the array do not have substantially the same volume, there is an increased probability that the balls will lack co-planarity.

Co-planarity is a critical factor for successful attachment of flip chips to BGA-type packages. If one or more balls are significantly shorter than others it becomes highly likely that these smaller (shorter) contacts will completely miss their mating contact pads and will fail to form an electrical connection between the semiconductor device and the package.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a schematic diagram of a screen printing apparatus according to an embodiment of this invention.

FIG. 2 illustrates a top view of a prior art stencil over a substrate.

FIG. 3A illustrates a side view of a prior art stencil over a substrate.

FIG. 3B illustrates a side view of a prior art stencil as the stencil is being removed from the substrate.

FIG. 3C illustrates a side view of a prior art stencil after the stencil is removed from the substrate.

FIG. 4 illustrates a top view of a stencil, positioned over a substrate.

FIG. 5A illustrates a side view of a stencil, according to one embodiment of this invention, over a substrate.

FIG. 5B illustrates a side view of a stencil, according to one embodiment of this invention, while the stencil is being removed from the substrate.

FIG. 5C illustrates a side view of a stencil, according to one embodiment of this invention, after removal of the stencil from the substrate.

FIG. 6 is a top view of a stencil according to another embodiment of this invention.

FIG. 7 is a top view of a stencil and frame according to yet another embodiment of this invention.

FIG. 8 is a top view of a stencil and frame according to still another embodiment of this invention.

The description set out herein illustrates the various embodiments of the invention and such description is not intended to be construed as limiting in any manner.

### DETAILED DESCRIPTION

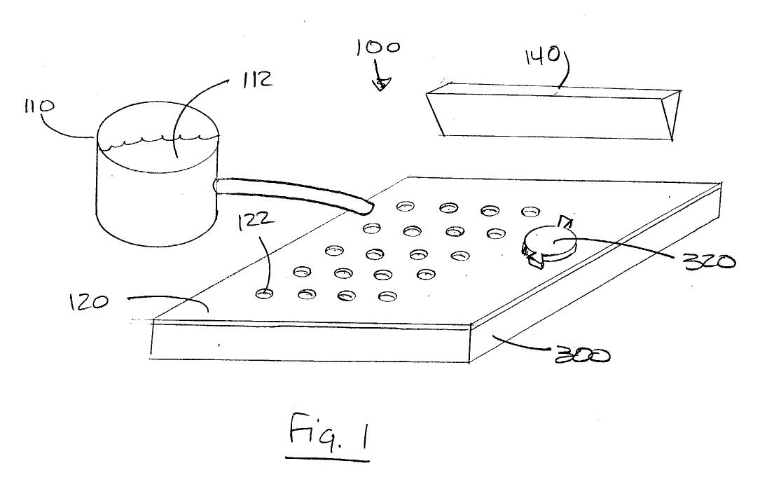

FIG. 1 is a schematic view of a screen printing apparatus 100. The screen printing apparatus 100 includes a reservoir 110, a printing stencil 120, and a substrate 300. The substrate includes a plurality of lands 502, 504 (shown in FIG. 5). The screen printing apparatus 100 allows for a printing medium, such as a printing paste or other conductive material, to be printed onto the substrate 300 in any predetermined pattern. In this particular application, the screen printing apparatus 100 is used to form a pattern that includes an array of bumps on a die or an array of bumps on a package that includes the die. Either the die or the package has a surface and structure that corresponds to a substrate 300. It should be noted that the substrate is not limited to a die or a substrate associated with a package. A substrate can be anything, including printed circuit boards or printed wire assemblies. In addition, the screen printing apparatus 100 can be used on a substrate 300 made of a variety of materials.

The reservoir 110 contains a printing paste 112. The printing paste is made up of solder and flux or conductive material. The printing stencil 120 comprises a sheet having a plurality of openings or apertures 122 therein. The apertures 122 are disposed within the printing stencil 120 such that they form a pattern thereon. The stencil 120 includes a vibration generator 320. The vibration generator 320 is attached either directly or indirectly to the printing stencil 120. The vibration generator induces vibration on the printing stencil 120 at a selected time. Therefore, the vibration generator 320 can be selectively enabled or disabled at the selected times.

In operation, the openings or apertures 122 in the printing stencil 120 are filled with solder paste. A wiping apparatus 140 is used to force the solder paste into the openings or apertures 122. The stencil 120 and specifically the openings 122 of the stencil 120 are devoid of solder pastes 112 in FIG. 1. FIGS. 5A-5C show an innovative embodiment of a stencil in which the openings include solder paste.

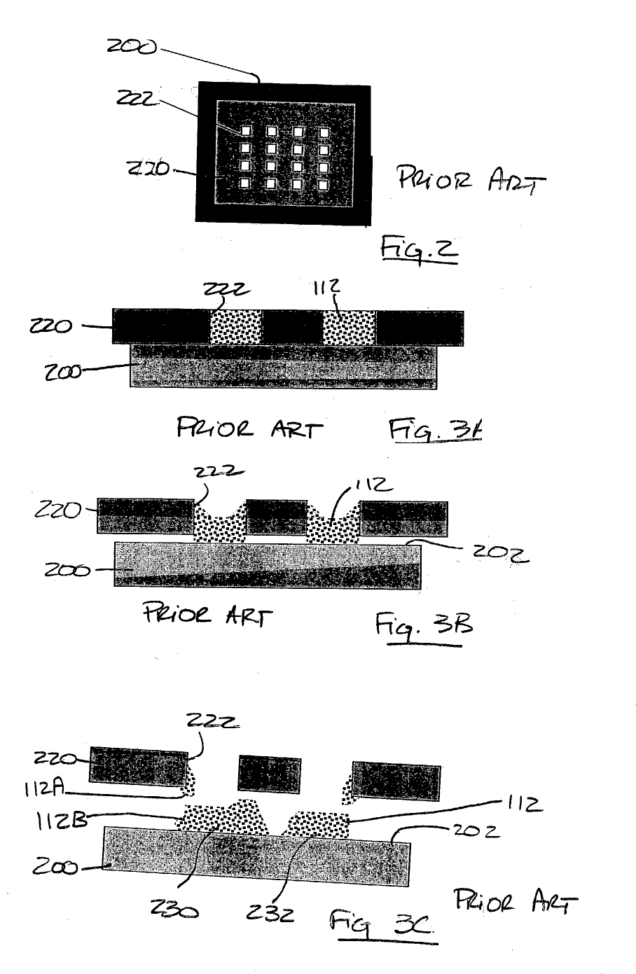

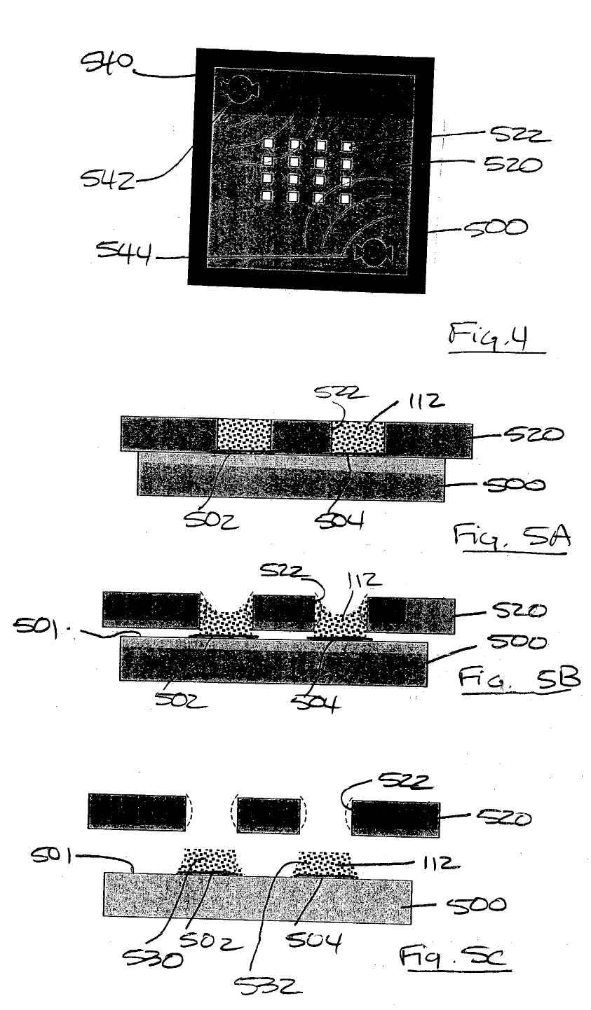

FIGS. 2, 3A, 3B, and 3C, illustrate various aspects of a prior art stencil 220 as positioned over a substrate 200. FIG. 2 illustrates a top view of a prior art stencil 220 positioned over a substrate 200. The stencil 220 includes a plurality of openings or apertures 222 having solder paste or other conductive material 112, therein. As shown in FIG. 2, there is no solder paste 112 within the apertures of the stencil 220.

FIGS. 3A-3C illustrate or show cross-sectional views of a prior art stencil 220 positioned over a substrate 200 as the stencil 220 is used to deposit solder paste 112 onto the substrate. FIG. 3A illustrates a side view of the prior art stencil over the substrate. The stencil 220 includes openings 222. The openings 222 are filled with solder paste 112 or other print medium. The stencil 220 is positioned adjacent the substrate 200. FIG. 3B illustrates a side view of the prior art stencil 220 as it is initially being removed from the substrate 200. The stencil 220 is lifted or removed from its position adjacent to substrate 200. The solder paste 112 is deposited onto the surface 202 of the substrate 200. The capillary force exists between the solder paste 112 and the openings 222 when the gaps or openings 222 become small. FIG. 3C illustrates a side view of the prior art stencil 220 after the stencil 220 is removed from the substrate 200. As can be seen when the stencil 220 is further removed from the substrate 200, the capillary forces between the opening or openings 222 and the solder paste 112 prevent all the solder paste 112 that was in the opening 222 from being deposited onto the surface 202 of the substrate 200. For example, as shown in FIG. 3C, the solder paste is divided into two portions. A first portion 112A remains in the opening 222 of the stencil 220. The second portion of the solder paste 112B is deposited onto the surface 202 of the substrate 200. Therefore, an uncontrolled separation occurs when the pitch of the gap or opening is small, such as when the pitch or the gap is below 150 microns.

The result of removing the stencil 220 from the substrate 200 is that two deposits, 230, 232 of solder paste 112B, 112, respectively, remain on the surface 202. The problem is that the deposits 230, 232 are not equal in size or equal in volume. Therefore, when the solder paste is heated to drive away the flux and leave only solder on the surface 202 of the substrate 200, the balls that will be formed will be unequal and will have heights that are also unequal. This, many times, results in a lack of co-planarity at the ball tips. A lack of co-planarity leads to many problems, including open electrical connections that result from the lower height balls not making electrical contact when the electrical device associated with the substrate 200 is connected to another substrate.

FIGS. 4 and 5A, 5B, 5C illustrate a stencil according to an embodiment of this invention. FIG. 4 illustrates a top view of a stencil 520 positioned over a substrate 500. The substrate 500 includes lands thereon. The lands 502, 504 are shown in FIGS. 5A, 5B, 5C. The stencil 520 includes apertures 522 that are placed in an array or placed in a pattern. The stencil also includes a vibration generation system 540. The vibration generation system 540 is also referred to as a vibration generator and can have one or more individual vibration generators associated therewith. As shown in FIG. 4 the vibration generation system 540 includes a first element or vibration generator 542 and a second vibration generator 544. The vibration generation system 540, which includes the first vibration generator 542 and the second vibration generator 544, is enabled or turned on to induce vibration in the stencil at a particular time during the deposition or screen-printing of a print media, such as the solder paste 112 onto the substrate 500. It should be noted that the vibration generation system 540 and individual vibration generators 542, 544 can vibrate at various frequencies, including the sonic and ultrasonic ranges.

FIGS. 5A, 5B, and 5C illustrate various stages of solder paste 112 or other print media being deposited upon the substrate 500 using the stencil 520. FIG. 5A illustrates a side view of the stencil 520, according to an embodiment of the invention. The stencil 520 is positioned over the substrate 500. The substrate 500 includes lands 502, 504. The stencil 520 has openings 522 which correspond in position to the position of the lands 502, 504 on the substrate 500. An initial step is to align the openings 522 in the stencil 520 with the lands 502, 504 on the substrate 500. Solder paste 112 or other print media is placed into the openings 522 in the stencil 520 while the stencil 520 is positioned adjacent or atop the substrate 500.

FIG. 5B illustrates a side view of the stencil 520 while the stencil 520 is being removed from the substrate 500. In FIG. 5B, the substrate 520 is beginning to be removed. There is capillary action between the print medium, such as the solder paste 112, and the opening 522, as is shown in FIG. 5B. FIG. 5C illustrates a side view of the stencil 520 after removal of the stencil 520 from the substrate 500. The vibration generation system 540 or the vibration generators 542, 544 are enabled or turned on to induce vibration in the stencil 520 as the stencil 520 is being removed from the substrate 500. The frequency of the vibration generators 542, 544 is selected based on various parameters, such as the type of print medium 112, the thickness of the stencil 520, and the size of the openings 522, among other things. The vibration generators, 542, 544 are positioned and sized so that the result is that the vibration induced in the stencil 522 overcomes the capillary action or capillary forces between the openings or the side of the openings 522 and the solder paste or other print medium 112 located within the openings. As shown in FIG. 5C, vibration is depicted by the broken lines that are shown around or near the side walls of the openings 522 in the stencil 520. Of course, after removal of the stencil 520 from the substrate 500, the vibration generators can be disabled or turned off. The result is that substantially all of the print medium or solder paste 112 within the opening 522 of the stencil 520 is deposited onto the surface 501 of the substrate 500. More specifically, the solder paste 112 or other print medium is fully removed or substantially fully removed from the opening, and placed upon at least a portion of the lands 502, 504 respectively. The deposits of the print media or solder paste 112 onto the lands 502, 504 have reference numerals 530, 532 respectively. The end result is that the deposits 530, 532 have substantially equal volume, so that when the substrate 500 with the deposits 530, 532 thereon is heated, substantially equal-sized balls having equal height will result. This, of course, results in a substantially co-planar array on the substrate 500.

It should be noted that the substrate 500 can be made of any material. A particular material commonly used in electrical applications is silicon. However, it is contemplated that this technique and this apparatus could also be used on substrates of other materials. In addition, it is also contemplated that the print media need not necessarily always be solder paste, but could be equally applicable to other print media as well.

FIG. 6 is a top view of a stencil 620 according to another embodiment of this invention. The stencil 620 includes openings or apertures 622 therein. The stencil 620 also includes a vibration generation system 640 which includes vibration generator 642, vibration generator 644, and vibration generator 646. As noted above, the frequency of vibration as well as the placement of the vibration generator, 642, 644, 646 is selected so that any capillary forces that may be formed between the openings or apertures 622 and the print media within the apertures are overcome by vibrations induced by vibration generators 642, 644, 646. The vibration generators 642, 644, 646 can be placed anywhere on the stencil. In this particular application, it is shown that there is a portion of the stencil 624 that has openings 622 therein and there is a portion of the stencil 626 which is solid, or is a solid sheet. In this particular embodiment, the vibration generators 642, 644, 646 are all placed on the solid portion 626 of the stencil 620. The solid portion 626 is generally about the perimeter of the portion 624 having openings 622 therein.

It should be noted that any geometric configuration or placement of the vibration generators 642, 644, 646 is contemplated by this invention. Furthermore, the number of vibration generators used is not limited to one, two or three vibration generators. The number of vibration generators used is sufficient to produce a vibration in the stencil 620 that overcomes any capillary force between the print medium within an opening or aperture 622 and the side walls of the aperture 622. Furthermore, it is contemplated that a wide variety of frequencies may be used to overcome these capillary forces and provide for removal of the entire amount, or substantially the entire amount, of print medium from an aperture 622. For example, the vibration generators 642, 644, 646 can operate or produce vibrations in the ultrasonic frequency range or in other frequency ranges.

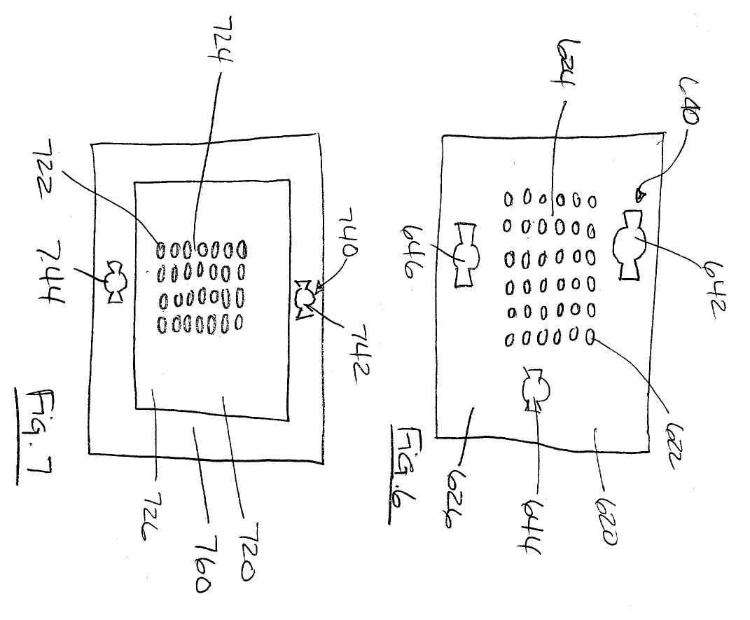

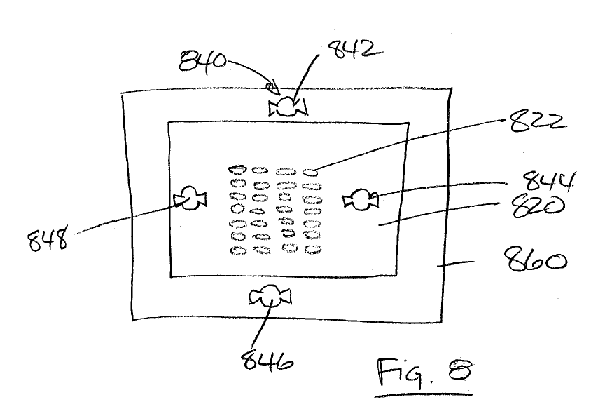

FIG. 7 is a top view of a stencil 720 and a frame 760 that is attached to the stencil 720, according to yet another embodiment of the invention. In this particular embodiment of the invention, the stencil 720 includes a solid portion 726 and a portion 724 that has openings or apertures 722 therein. Attached to the frame 760 is a vibration generation system 740 that includes a first vibration generator 742 and a second vibration generator 744. In this particular embodiment, the first vibration generator 742 and second vibration generator 744 are directly attached to the frame. Enabling the first vibration generator 742 and second vibration generator 742 attached to the frame 760 induces a vibration in the frame 760 as well as in the stencil 720.

FIG. 8 is a top view of a stencil 820 and attached frame 860 according to still another embodiment of this invention. The stencil 820 includes openings or apertures 822. The stencil 820 and frame 860 include a vibration generation system 840 which has a vibration generator 842, a vibration generator 844, a vibration generator 846, and a vibration generator 848. The vibration generators 842 and 846 are attached to the frame 860. The vibration generators 844 and 848 are directly attached to the stencil 820.

It should be noted that the vibration generators can be attached to either the frame 860 or the stencil 820, or a combination of the frame and stencil. It should also be noted that the geometric positioning or distribution of the vibration generators is not limited to the pattern shown in the figures. Again, the placement, frequency, and size of the vibration generators 842, 844, 846, 848 are selected to induce vibration in the stencil 820 so that any capillary force between the print medium within an aperture and the side walls of the aperture are overcome as the stencil is being removed from the substrate (not shown). It should also be noted that the lands may be provided with a solder mask to restrict the amount or portion of the area of the land that is being covered. The use of a solder mask is optional and, again, dependent upon the material of the substrate. Some materials may require a mask, other materials may not require a mask, and for still other materials the mask is optional and at the selection and desire of the user.

A method for screen printing onto a substrate includes positioning a stencil having an opening therein over a substrate, filling the openings in the stencil with solder paste, and vibrating the stencil to release the solder paste within the opening and deposit the solder paste onto the substrate. In some embodiments, the stencil is vibrated in the ultrasonic frequency range. In some embodiments, vibrating the stencil includes vibrating a first portion of the stencil and vibrating a second portion of the stencil. Filling the openings in the stencil with solder paste includes wiping the surface of the stencil. In some embodiments, the area on the substrate that the solder paste contacts is restricted. The area can be restricted by masking an area on the substrate. When a mask is used, the solder paste contacts an unmasked area of the substrate.

A method for forming a plurality of solder balls on a plurality of lands on a substrate includes masking the substrate to restrict the attachment of the plurality of solder balls to a portion of the plurality of lands, positioning a stencil having a plurality of openings therein over the mask and substrate, filling the openings in the stencil with solder paste, vibrating the stencil to release the solder paste within the opening and to deposit the solder paste onto the substrate, and removing the stencil from the substrate. The method also includes heating the substrate with solder paste deposited thereon to form a plurality of solder balls. In some embodiments, the method also includes removing the mask. Positioning the stencil having a plurality of openings therein includes aligning the openings in the substrate with the lands on the substrate.

A stencil for use in screen printing includes a sheet having openings therein, and a vibration generator attached to the sheet. The sheet further includes a solid portion, and a portion having the openings therein. The vibration generator is attached to the solid area of the sheet. In one embodiment, the vibration generator includes at least one ultrasonic generator. In another embodiment, the vibration generator includes a plurality of ultrasonic generators. The vibration generators are attached at a plurality of positions on the solid portion of the stencil. In some embodiments, the stencil further includes a frame attached to the stencil. The vibration generator is attached to the frame. The vibration generator attached to the frame can include a plurality of ultrasonic generators at a plurality of positions on the frame.

A screen printing apparatus includes a source of solder paste. The solder paste further includes solder and flux. The screen printing apparatus also includes a stencil having openings therein, and an apparatus for forcing the solder paste into the openings of the stencil. The screen printing apparatus also includes a source of vibration attached to the stencil. In some embodiments, the source of vibration is an ultrasonic generator or a plurality of ultrasonic generators. The ultrasonic generator or plurality of ultrasonic generators are positioned to overcome a surface tension between the solder paste and an opening in the stencil. The apparatus for forcing the solder paste into the openings of the stencil of the screen printing apparatus includes a wiper.

The method and structures shown and described in the above figures and description provide many advantages. Using the inventive method and structure results in the balls of a ball grid array type device being substantially equal in volume and substantially co-planar. In other words, the difference in ball height at the free end of the balls will be within a standard specification for co-planarity. The method allows for even deposition of solder paste on a substrate with pitches of 150 microns or more. The solution is inexpensive and easily implemented. The result is a ball grid array device that presents a co-planar surface and has good connectivity with no shorts to other components in different applications.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A stencil for use in screen printing, the stencil comprising:
a sheet having openings therein; and
a vibration generator attached to the sheet.

2. The stencil of claim 1 wherein the sheet is further comprised of:
a solid portion; and
a portion having the openings therein, the vibration generator attached to the solid area of the sheet.

3. The stencil of claim 1 wherein the vibration generator includes at least one ultrasonic generator.

4. The stencil of claim 1 wherein the vibration generator includes a plurality of vibration generators.

5. The stencil of claim 2 wherein the vibration generator includes a plurality of vibration generators attached to at plurality positions on the solid portion of the sheet.

6. The stencil of claim 1 further comprising a frame attached to the stencil, the vibration generator attached to the frame.

7. The stencil of claim 6 wherein the vibration generator includes a plurality of vibration generators.

8. The stencil of claim 6 wherein the vibration generator includes a plurality of vibration generators attached at a plurality positions on the frame.

9. The stencil of claim 1 further comprising a frame attached to the stencil, the vibration generator attached to the frame and to the stencil.

10. A screen printing apparatus comprising:
a source of solder paste, the solder paste further including solder and flux; a stencil having openings therein;
an apparatus for forcing the solder paste into the openings of the stencil; and
a source of vibration attached to the stencil.

11. The screen printing apparatus of claim 10 wherein the source of vibration is an ultrasonic generator.

12. The screen printing apparatus of claim 10 wherein the source of vibration includes a plurality of vibration generators.

13. The screen printing apparatus of claim 10 wherein the source of vibration includes a plurality of vibration generators positioned to overcome a surface tension between the solder paste and an opening in the stencil.

14. The screen printing apparatus of claim 10 wherein the apparatus for forcing the solder paste into the openings of the stencil includes a wiper.

15. A method for screen printing onto a substrate comprising:
positioning a stencil having an opening therein over a substrate;
filling the openings in the stencil with solder paste; and
vibrating the stencil to release the solder paste within the opening and deposit the solder paste onto the substrate.

16. The method of claim 15 wherein vibrating the stencil includes vibrating the stencil in the sonic frequency range.

17. The method of claim 15 wherein vibrating the stencil includes
vibrating a first portion of the stencil; and
vibrating a second portion of the stencil.

18. The method of claim of claim 15 wherein filling the openings in the stencil with solder paste includes wiping the surface of the stencil.

19. The method of claim 15 further comprising restricting the amount of the area on the substrate that the solder paste contacts.

20. The method of claim 15 further comprising masking an area on the substrate, the solder paste contacting an unmasked area of the substrate.

21. A method for forming a plurality of structures on a plurality of lands on a substrate comprising:
masking the substrate to restrict the attachment of the plurality of solder balls to a portion of the plurality of lands;
positioning a stencil having a plurality of openings therein over the mask and substrate;
filling the openings in the stencil with solder paste;
vibrating the stencil to release the solder paste within the opening and deposit the solder paste onto the substrate; and removing the stencil from the substrate.

22. The method of claim 21 further comprising heating the substrate with solder paste deposited thereon to form a plurality of solder balls.

23. The method of claim 21 further comprising pressurizing the substrate with solder paste deposited thereon to form a plurality of solder balls.

24. The method of claim 21 further comprising:
heating the substrate with solder paste deposited thereon to form a plurality of solder balls; and
pressurizing the substrate with solder paste deposited thereon to form a plurality of solder balls.

25. The method of claim 21 further comprising removing the mask.

26. The method of claim 21 wherein positioning the stencil having a plurality of openings therein includes aligning the openings in the substrate with the lands on the substrate.
